(19) United States
(12) Patent Application Publication
(10) Pub. No.: US 2002/0088644 A1
(43) Pub. Date: Jul. 11, 2002

(54) Cables, cable systems, parts and methods

(76) Inventor: Gregory Neil Burland, London (GB)

Correspondence Address: CONNOLLY BOVE LODGE & HUTZ LLP, SUITE 800, 1990 M STREET NW, WASHINGTON, DC, 20036-3425, US

(21) Appl. No.: 10/013,553

(22) Filed: Dec. 13, 2001

(30) Foreign Application Priority Data
Dec. 13, 2000 (GB) 0030569.8

(51) Int. Cl. H01B 7/00

(52) U.S. Cl. 174/135

(57) ABSTRACT

A cable system is made up of several cables each having several wires extending side-by-side. The wires in each cable are retained together in a flat configuration by removable clips and these are retained together in frames. The clips at the end of the cables support the wires so that they can all be stripped and attached to connector contacts together.

### BACKGROUND OF THE INVENTION

This invention relates to cables, cable systems, parts and methods.

Conventional cable systems include a bundle of wires connected at opposite ends to respective connectors. The bundle of wires is usually of a generally circular section, which can cause difficulties. Because the wires do not retain a predetermined position within the bundle along its length they have to be marked in some way for identification purposes. It also means that the wires have to be individually stripped of insulation and terminated, which is time consuming. Because each wire may extend close to any other wire, signals on one wire can cause interference on any other wire. For this reason, there are advantages to flat cable systems where each wire extends side-by-side at a predetermined position across a row of wires. There are, however, problems with flat cable systems. The manufacture of flat cables where the insulation is formed integrally for all the wires requires specialised manufacturing equipment leading to extra costs, especially where varying numbers or types of wires are provided in a cable. For the same reason, it can also be difficult to secure separate wires in a flat configuration such as by bonding to one another or to a parallel support sheet. Flat cables can also be difficult to bend in a curve lying in the plane of the cable.

### BRIEF SUMMARY OF THE INVENTION

It is an object of the present invention to provide an alternative cable, cable system, part and method.

According to one aspect of the present invention there is provided a cable having a plurality of separate wires and a plurality of retaining members spaced from one another along the cable, the retaining members locating the wires side-by-side with one another in a planar array.

The retaining members preferably retain the wires in a removable manner. The retaining members preferably have a plurality of separate locations adapted to receive respective individual ones of the wires. The locations may be passages through the retaining member. The retaining members are preferably clips fastened about the wires. Each clip may have two arms hinged with one another at one end and provided with locking catches at the other end.

According to another aspect of the present invention there is provided a retaining member for use in a cable according to the above one aspect of the invention.

According to a further aspect of the present invention there is provided a cable system including a cable according to the above one aspect of the present invention and a connector having a plurality of contact members connected with respective ones of the wires.

According to a fourth aspect of the present invention there is provided a method of forming a cable including the steps of providing a plurality of wires, retaining the wires side-by-side with one another in a flat configuration using a plurality of retaining members, locating wire forming means with the cable against a retaining member and effecting a wire forming operation with the wire forming means on each wire simultaneously.

The wire forming operation may be stripping of insulation.

According to a fifth aspect of the present invention there is provided a method of forming a cable system including the steps of providing a plurality of groups of wires, retaining the wires side-by-side with one another in a plurality of groups using a plurality of retaining members, each group having a flat configuration, and retaining the groups with one another in an array with retaining means.

According to a sixth aspect of the present invention there is provided a cable formed by a method according to the above fifth aspect of the invention.

A cable system including a cable and retaining members, and a method of forming the cable, according to the present invention, will now be described, by way of example, with reference to the accompanying drawings.

### BRIEF DESCRIPTION OF THE DRAWINGS

FIG. 1 is a perspective view of the cable system;

FIG. 2 is a side elevation view of the system;

FIG. 3 is a perspective view of a cable of the system;

FIG. 4 is a transverse cross-sectional view across a single retaining clip of the system;

FIG. 5 is a transverse cross-sectional view across a group of four retaining clips;

FIG. 6 is transverse cross-sectional view across an alternative retaining clip; and

FIGS. 7 to 10 illustrate steps in forming the cable system.

### DETAILED DESCRIPTION OF THE PREFERRED EMBODIMENT

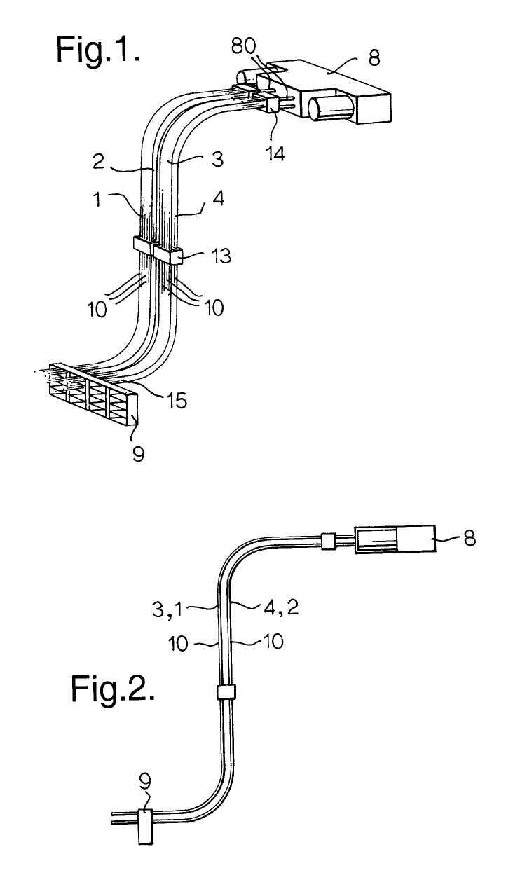

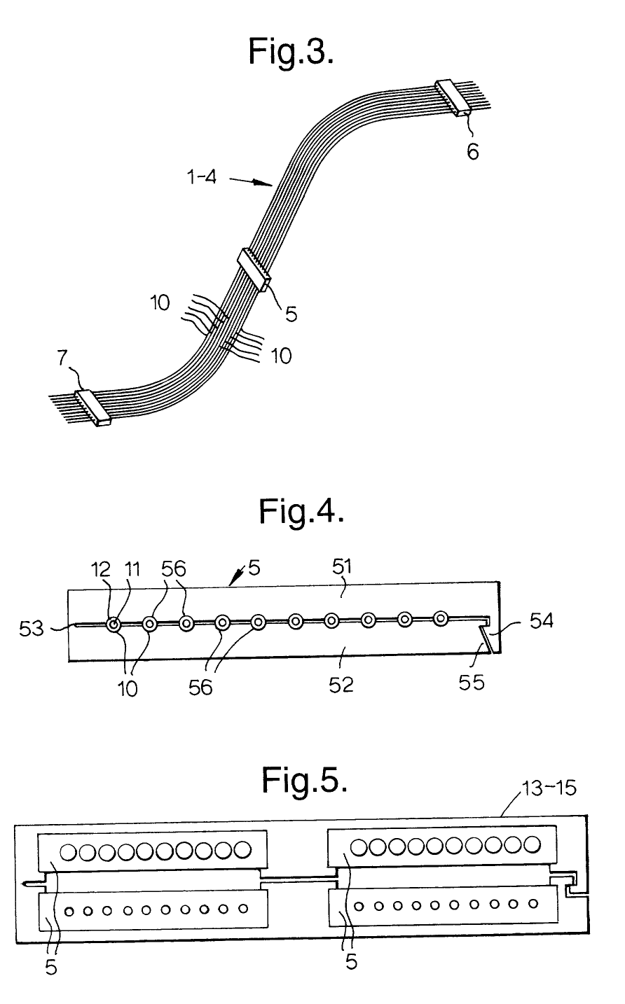

With reference first to FIGS. 1 to 4, the cable system includes four cables 1 to 4 each having a bundle of ten wires 10 arranged in a flat configuration, with the four cables being arranged in a two-by-two array. Each cable 1 to 4 has three retaining members or clips, one clip 5 (FIG. 3) being located midway along the length of the cable and the other two 6 and 7 being located close to opposite ends. The system includes two connectors 8 and 9 to which individual ones of the forty wires 10 in the cables 1 to 4 are connected at opposite ends.

The wires 10 in the cables 1 to 4 are separate from one another and may be identical with or differ from one another, each typically comprising a conductor 11 extending within an insulating sleeve 12. One or more of the wires 10 may be screened by an outer braided sleeve, in the usual way. The retaining clips 5 to 7 are identical with one another and may be of various different constructions enabling the wires 10 to be retained side-by-side with one another in a flat, planar configuration. In the example shown in FIG. 4, the clip 5 is an integral moulding of a plastics material comprising two arms 51 and 52 hinged with one another at one end by a web 53 and having at their opposite ends cooperating catches 54 and 55. Each arm 51 and 52 has ten recesses 56 of semi-circular section spaced along its length and adapted to receive an individual one of the wires 10 when the two arms are closed about the wires. The size of the recesses 56 is such that the wires 10 are firmly gripped when the clip is closed. The three clips 5 to 7 on each cable 1 to 4 are themselves retained with one another by a respective outer frame 13 to 15 in a two-by-two array, as shown in FIG. 5.

Because the wires 10 in the cables 1 to 4 are separate from one another they do not need any special manufacturing. The clips 5 to 7 can be secured on the cables 1 to 4 at any convenient stage of manufacture and can easily be unfastened to allow for removal or replacement of wires. The clips 5 to 7 also allow the cables 1 to 4 to be bent readily in a bend lying in the plane of the wire bundles by releasing the clips to allow the wires to be pulled through as necessary and then fastening the clips again.

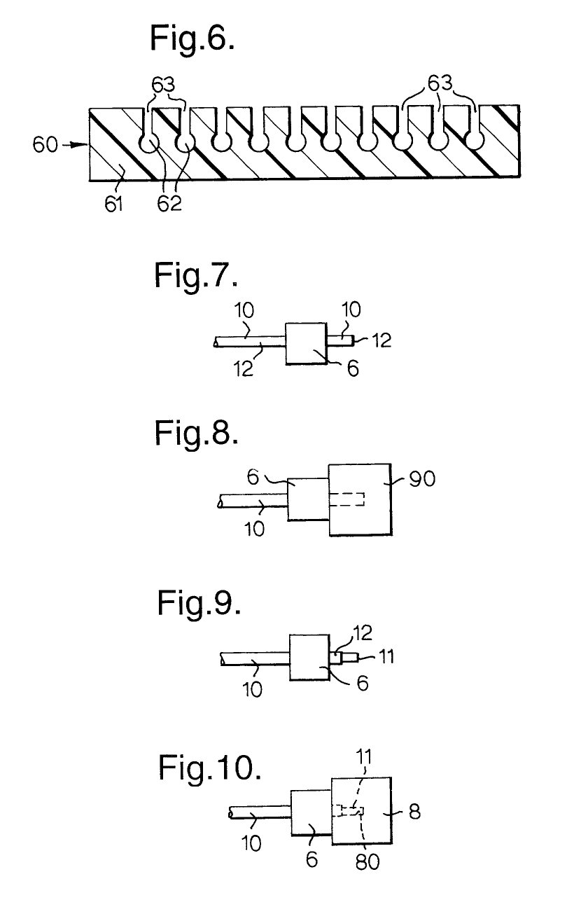

The retaining means could take various different forms, such as shown in FIG. 6, where the retaining means 60 comprises a block 61 of a stiff, resilient plastics material having ten passages 62 of circular section extending therethrough arranged side-by-side with one another and each opening on one side of the block via a throat 63 of reduced width. Wires 10 are assembled in the retainer 60 by pushing each through one of the throats 63 into a respective passage 62.

The retaining means also have the advantage of facilitating forming operations on the ends of the wires 10, such as stripping off the insulation sleeve 12 and soldering to a contact 80 of the connectors 8 and 9. As shown in FIG. 7, the clip 6 at one end of a cable 1 is fastened about the wires 10 to allow a small length of the wires to protrude. FIG. 8 shows a wire-forming machine, in this case a tool or machine 90 for stripping off the insulation sleeve 12, brought up to the cable 1 to contact and locate against the clip 6. The stripping machine 90 may be a form of a conventional stripper used with single wires modified to strip simultaneously the insulation from the ten wires 10 protruding from the clip 6. The clip 6 ensures that the ends of the wires 10 are correctly located relative to the stripping machine 90 to enable this operation to be performed. The machine 90 is then removed, as shown in FIG. 9. The next step, as shown in FIG. 10 is to bring up the connector 8 so that the exposed ends of the wires 10 project into contacts 80 in the connector. Again, the connector 8 is located against the clip 6 to ensure correct positioning relative to the wires. The wires 10 are then soldered into the contacts 80 in the usual way. This end forming and terminating operation may be performed separately on each of the four cables 1 to 4, that is, ten wires at a time, or it may be performed simultaneously on the forty wires in the group of four cables after retaining the clips 6 in the outer frame 14 and by locating the forming machine with the frame.

It will be appreciated that the invention could be modified in various ways.

What I claim is:

1. A cable comprising: a plurality of separate wires; and a plurality of retaining members, said retaining members being spaced from one another along said cable and locating said wires side-by-side with one another in a planar array.

2. A cable according to claim 1, wherein said retaining members retain said wires in a removable manner.

3. A cable according to claim 1, wherein said retaining members have a plurality of separate locations, and wherein said locations are adapted to receive respective individual ones of said wires.

4. A cable according to claim 3, wherein said locations are passages through said retaining member.

5. A cable according to claim 1, wherein said retaining members are clips fastened about said wires.

6. A cable according to claim 5, wherein each said clip has two arms, wherein said arms are hinged with one another at one end, and wherein said arms have locking catches at an opposite end.

7. A cable system comprising: a plurality of cables, each cable having a substantially flat configuration and including a plurality of wires and a plurality of removable retaining clips retaining said wires side-by-side with one another; and a plurality of frames retaining the clips with one another.

8. A cable system according to claim 7, including a connector at opposite ends, said connector having contacts connected with each said wire.

9. A method of forming a cable comprising the steps of: providing a plurality of wires; retaining said wires side-by-side with one another in a flat configuration using a plurality of retaining members; locating a wire forming tool with said cable against one of said retaining members; and effecting a wire forming operation with said wire forming tool on each wire simultaneously.

10. A method according to claim 9, wherein the wire forming operation is stripping of insulation.

11. A method of forming a cable system comprising the steps of: providing a plurality of groups of wires; retaining said wires side-by-side with one another in a plurality of groups using a plurality of retaining members, each group having a flat configuration; and retaining said groups with one another in an array with retaining means.
